(19) United States
(12) Patent Application Publication
(10) Pub. No.: US 2014/0112348 A1
(43) Pub. Date: Apr. 24, 2014

(54) TRAFFIC FLOW MANAGEMENT WITHIN A DISTRIBUTED SYSTEM

(71) Applicant: BROADCOM CORPORATION, Irvine, CA (US)

(72) Inventors: Brad Matthews, San Jose, CA (US); Puneet Agarwal, Cupertino, CA (US)

(73) Assignee: BROADCOM CORPORATION, Irvine, CA (US)

(21) Appl. No.: 13/721,445

(22) Filed: Dec. 20, 2012

Related U.S. Application Data
(60) Provisional application No. 61/715,448, filed on Oct. 18, 2012.

(51) Int. Cl. H04L 12/56

(52) U.S. Cl. CPC H04L 45/44; H04L 49/30
USPC 370/400; 370/419

(57) ABSTRACT

Various methods and systems are provided for traffic flow management within distributed traffic. In one example, among others, a distributed system includes egress ports supported by nodes of the distributed system, cut-through tokens (c-tokens) including an indication of eligibility of the corresponding egress port to handle cut-through traffic, and a cut-through control ring to pass the c-tokens between the nodes. In another example, a method includes determining whether an egress port is available to handle cut-through traffic based upon a corresponding c-token, claiming the egress port for transmission of at least a portion of a packet, and routing it to the claimed egress port for transmission. In another example, a distributed system includes a first node configured to modify an eligibility indication of a c-token before transmission to a second node configured to route at least a portion of a packet based at least in part upon the eligibility indication.

### CROSS REFERENCE TO RELATED APPLICATIONS

This application claims priority to copending U.S. provisional application entitled “TRAFFIC FLOW MANAGEMENT WITHIN A DISTRIBUTED SYSTEM” having Ser. No. 61/715,448, filed Oct. 18, 2012, which is hereby incorporated by reference in its entirety.

### BACKGROUND

For user facing applications, the responsiveness and quality of a distributed network computing system supporting the application directly affects the user's perception of the application. System bandwidth and latency can directly impact the user's interaction with the application. A traditional approach of increasing the operating frequency of the system is becoming less viable to meet the desired bandwidth.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1 and 5 are graphical representations of examples of a distributed system in accordance with various embodiments of the present disclosure.

FIGS. 2A and 2B illustrate examples of c-tokens of FIGS. 1 and 5 in accordance with various embodiments of the present disclosure.

FIG. 3 illustrates an example an ordered sequence of c-tokens of FIGS. 1 and 5 in accordance with various embodiments of the present disclosure.

FIG. 4 is a graph illustrating the effect of bandwidth on latency of c-tokens of FIGS. 1 and 5 in accordance with various embodiments of the present disclosure.

FIG. 6 is a flow chart illustrating an example of traffic flow management within a distributed system of FIGS. 1 and 5 in accordance with various embodiments of the present disclosure.

FIG. 7 is schematic block diagram of an example of a node employed in the distributed system of FIGS. 1 and 5 in accordance with various embodiments of the present disclosure.

### DETAILED DESCRIPTION

Disclosed herein are various embodiments of methods and systems related to traffic flow management within distributed traffic. Reference will now be made in detail to the description of the embodiments as illustrated in the drawings, wherein like reference numbers indicate like parts throughout the several views.

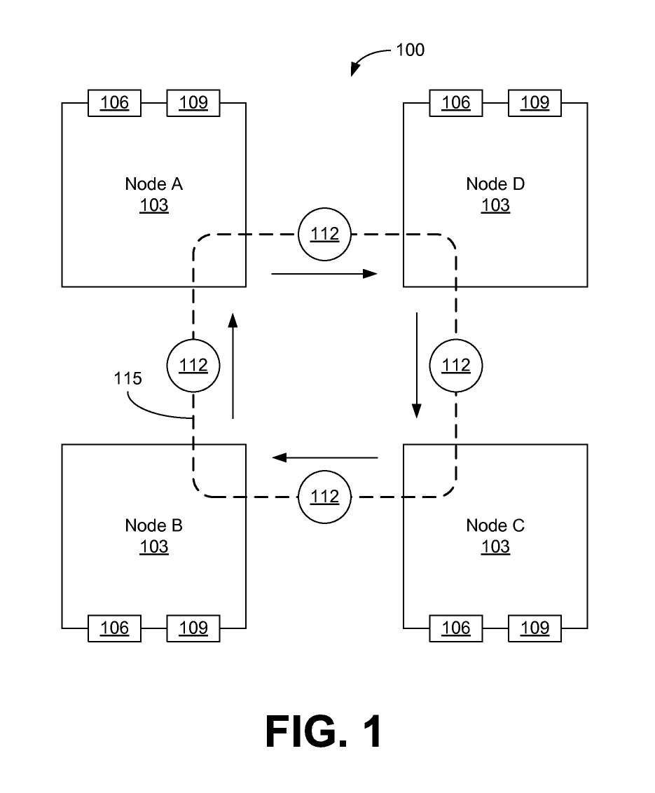

Referring to FIG. 1, shown is a graphical representation of an example of a distributed system 100 including a plurality of nodes 103 that are communicatively coupled to allow traffic such as packets and/or frames to be passed between and/or through the nodes 103. For example, a switch such as, e.g., a network switch or rack switch may include a distributed system 100 that controls the traffic flow through the switch. Each node 103 may support one or more ingress ports 106, one or more egress ports 109, or any combination of ingress and egress ports 106/109. While the example of FIG. 1 illustrates an ingress port 106 and an egress port 109 supported by each node 103, other combinations of ingress and/or egress ports 106/109 are possible as can be understood. When supporting traffic flow is received through an ingress port 106 of the distributed system 100 the supporting node 103 may be referred to as an ingress node and when supporting traffic flow departs through an egress port 109 the supporting node 103 may be referred to as an egress node. As can be understood, a node 103 may be considered both an ingress node and an egress node based upon the type of traffic flow that is being handled by the node 103.

The nodes 103 of the distributed system 100 may represent a single die in a chip, multiple chips in a device, and/or multiple devices in a system and/or chassis. For example, a distributed system 100 may be implemented using one or more chips. In one embodiment, a plurality of chips may be communicatively coupled to allow packet and/or frame traffic to flow between the chips. Each chip may be configured to handle the traffic communicated between the chips and/or through the supported ingress and/or egress ports 106/103. In other embodiments, the distributed system 100 may be implemented as a single chip including a plurality of communicatively coupled cores as the nodes 103. The cores may be configured to handle traffic flow communicated between the cores and/or through the supported ingress and/or egress ports 106/103. In some implementations, a node 103 may include a buffer and/or memory to store a portion of the traffic flowing through the node 103.

When a pull architecture is used by the distributed system 100, an egress node provides each ingress node an allowance for the amount of data (e.g., packets and/or frames) that it is permitted to send to the egress node. In this way, the rate at which the data arrives at the egress node equals or closely approximates its processing rate. Traffic that is provided by an ingress node in accordance with the corresponding allowance is considered to be scheduled traffic. Traffic sent in excess of the allowance can be considered to be unscheduled traffic. When a push architecture is used, an ingress node forwards packets and/or frames to one or more egress nodes at the highest rate possible. In this case, the rate at which the data arrives at the egress node can exceed its maximum processing rate. Traffic in excess of the maximum transmission rate of an egress port 109 may be considered to be unscheduled traffic. When the processing rate is exceeded, the egress node can instruct the ingress node(s) to stop sending (or reduce) traffic using a flow control.

When incoming data is received through an ingress port 106, a buffer of the corresponding ingress node may be used to accumulate the data until the full frame or packet is received. At that point, the ingress node can send the frame and/or packet to an egress node for transmission through a supported egress port 109. Cut-through switching may be used to reduce the latency experienced by the data accumulation by forwarding a portion of the packet and/or frame to the egress node before the full packet and/or frame is received by the ingress node. The portion of the packet and/or frame is sent to the egress port 109 without buffering or storing the data. Since a portion of the data may be sent before the entire frame and/or packet is received, errors may not be identified at the ingress node before the data is sent to the egress node. However, the reduction in the transmission latency may offset the bandwidth cost associated with sending a bad packet through the network.

For example, large data centers desire very high bandwidth aggregation devices (or switches) to handle requests from their customers. Latency is a key metric for user facing applications as it determines responsiveness and/or quality of the results to a user request. To satisfy the user's needs, such systems should support both high bandwidth and low latency for packet and/or frame routing and/or delivery. Because the frequency gains between successive technology generations is reducing, scaling to meet bandwidth needs using a traditional approach of increasing the operating frequency is becoming less viable. Distributed multi-node systems offer the ability to meet the bandwidth needs by scaling the processing. Cut-through switching can be used to achieve low latency operation in a distributed system 100. The cut-through behavior should be transparent to the user or other external observer.

To reduce the latency, a cut-through eligibility (or state) of the egress port 109 can be used to indicate whether traffic can be transmitted immediately upon its reception at the supporting node 103. For an egress port 109 to be eligible to handle cut-through traffic, the egress port 109 must be idle with no constraints that would prevent immediate transmission through the egress port 109 upon receipt of the cut-through traffic. However, other quality of service (QoS) guarantees such as port shaping and queue shaping guarantees should be honored. Thus, to coordinate cut-through traffic flow between the nodes 103 with other QoS requirements, a cut-through eligibility indication for each egress port 109 may be sent to each of the nodes 103 supporting an ingress port 106.

To further reduce the latency, the delay in coordinating the cut-through decisions should also be reduced or minimized. This may be accomplished by eliminating the need for a request-response handshake to determine availability of an egress port 109. In general, a request-response handshake is carried out to determine whether an egress port 109 is able to receive cut-through traffic. Initially, a request is sent by an ingress node to an egress node to determine whether a specified egress port supported by the egress node is available to handle cut-through traffic. The egress node may then send a reply indicating whether the egress port is eligible to handle cut-through traffic. If so, then the ingress node may begin routing cut-through traffic to the egress port. If not, then the ingress node repeats the handshake by sending another request to determine eligibility of the egress port. Thus, system latency can be reduced by removing the need to carry out the request-response handshake between the nodes 103. Instead, a token may be used to indicate the eligibility of an egress port 109 to handle cut-through traffic to other nodes 103 of the distributed system 100.

In the example of FIG. 1, the eligibility indication of an egress port 109 is provided to each of the plurality of nodes 103 via a cut-through token (c-token) 112 that corresponds to the egress port 109. The c-tokens 112 for each egress port 109 are passed between the nodes 103 over a cut-through control ring (c-ring) 115. Each node 103 becomes aware of the eligibility of an egress port 109 to handle cut-through traffic based at least in part upon the eligibility indication of the corresponding c-token 112. In the example of FIG. 1, the plurality of c-tokens 112 are passed along the c-ring 115 to each of the nodes 103 in a defined sequence. In this way, each c-token 112 is passed from the node 103 supporting the corresponding egress port 109 to each of the other nodes 103 of the distributed system 100 before returning to the supporting node 103.

When an ingress node receives the c-token 112 that indicates that the corresponding egress port 109 is available to transmit cut-through traffic, the ingress node may claim the use of the corresponding egress port 109 and route at least a portion of a packet and/or frame to the egress port 109 for immediate transmission. For cut-through traffic, the portion of a packet and/or frame may be immediately routed from the ingress port 106 to the egress port 109 without buffering or storing. The cut-through traffic sent by the ingress node should experience no buffering due to contention at the egress port 109. The ingress node may also modify a claim indication of the c-token 112 to notify the other nodes 103 that the corresponding egress port is currently being used. In this way, the ingress node indicates that the corresponding egress port 109 is not currently available for cut-through traffic.

If an incoming packet and/or frame is received through an ingress port 106 before the supporting node 103 receives an indication that the corresponding egress port 109 is available to receive cut-through traffic, then some or all of the incoming packet and/or frame may be stored in a buffer or memory for subsequent transmission through the egress port 109. For example, a virtual output queue (VOQ) of the ingress node may temporarily store packets and/or frames for transmission via the corresponding egress port 109. When the ingress node receives the c-token 112 that indicates that the corresponding egress port 109 is available to transmit cut-through traffic, the ingress node may claim the corresponding egress port 109 and route the buffered or stored portion of the packet and/or frame to the egress port 109 for transmission. The ingress node also modifies the claim indication of the c-token 112 to notify the other nodes 103 that the corresponding egress port is currently being used.

When the ingress node completes the routing of the packet(s) and/or frame(s) to the egress port 109, then the next time the ingress node receives the c-token 112 it may modify the claim indication to notify the other nodes 103 that the corresponding egress port 109 is no longer claimed. In other implementations, the claim may expire based upon a predefined claim limit such as, e.g., a time period during which traffic may be sent to the egress port 109 or a defined amount of data (e.g., a number of bytes or a number of packets and/or frames) that may be sent to the egress port 109. In some implementations, the claim limit may be a predefined number of times that the c-token 112 returns to the ingress node. When the predefined claim limit has expired, then the ingress node or the egress node may modify the claim indication to indicate that it is no longer claimed, which allows other ingress nodes to claim the corresponding egress port 109.

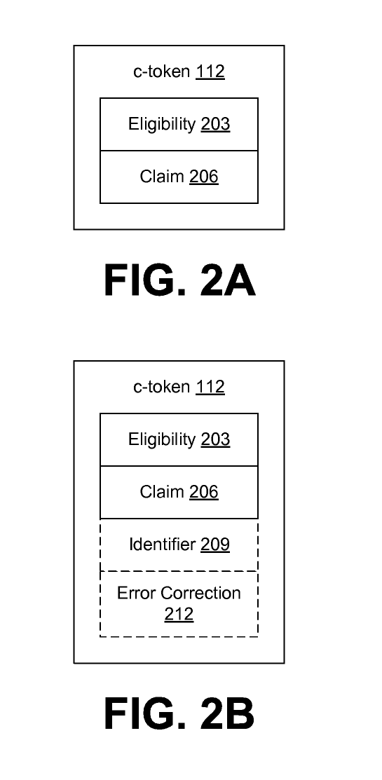

Referring to FIGS. 2A and 2B, shown are examples of c-tokens 112 in accordance with various embodiments of the present disclosure. In the example of FIG. 2A, the c-token 112 includes an indication of the eligibility 203 of the corresponding egress port 109 to handle cut-through traffic. The eligibility indication 203 may be a single bit with, e.g., “1” indicating that the corresponding egress port 109 is available to handle cut-through traffic and “0” indicating that the corresponding egress port 109 is not available. The egress port 109 may not be eligible to handle cut-through traffic because other scheduled traffic is being transmitted through the egress port 109. For example, the node 103 supporting the egress port 109 may include one or more queues (e.g., a priority queue) that store packets and/or frames that are scheduled for transmission via the corresponding egress port 109. If transmission conditions of the queue(s) are not satisfied, then the queue(s) may be on hold and the egress port 109 is idle. When the egress port 109 is idle, it is considered eligible for cut-through traffic and the eligibility indication 203 of the corresponding c-token 112 may be modified by the node 103 supporting the egress port 109.

The c-token 112 may also include a claim indication 206 that indicates whether the corresponding egress port 109 has been claimed by a node 103 supporting an ingress port 106 for transmission of traffic through the corresponding egress port 109. The claim indication 206 may be a single bit with, e.g., “1” indicating that the corresponding egress port 109 has been claimed for transmission and “0” indicating that the corresponding egress port 109 has not been claimed by a node 103. When a node 103 claims the corresponding egress port 109, then the node 103 modifies the claim indication 206 by, e.g., changing the bit value from “0” to “1.” The c-token 112 may also include an identifier 209, as shown in FIG. 2B, which identifies the node 103 that claimed the corresponding egress port 109 for use.

Referring to FIG. 2B, the c-token 112 may include additional information such as, e.g., error correction information 212. Error correction may be carried out one of many different ways. For example, a cyclic redundancy check (CRC) may be computed and validated across all of the c-tokens 112 using the error correction information 212. While the control bandwidth is distributed the c-tokens 112, this incurs latency by having to process all of the c-tokens 112 in the sequence before the validation is complete. In other implementations, the error correction information 212 may include an error correction code (ECC). In this way, each c-token 112 is ECC-protected and may be checked by a node 103 upon receipt of the c-token 112. This increases the control bandwidth of each c-token 112, but reduces the latency in validation.

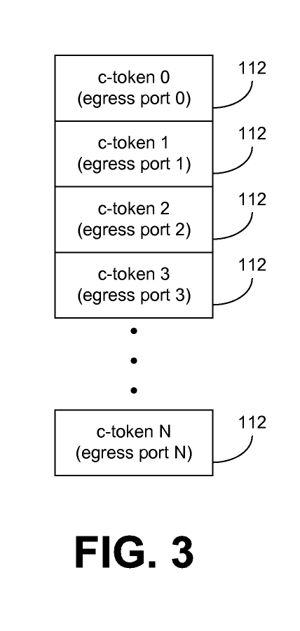

In some embodiments, a c-token 112 may also include an identifier for the corresponding egress port 109. In other embodiments, the position of a c-token 112 within the sequence of c-tokens 112 on the c-ring 115 indicates which of the egress ports 109 corresponds to the c-token 112. By tracking the c-tokens 112 that are passed along the c-ring 115, each node 103 can identify the egress port 109 that corresponds to the c-token 112. Referring to FIG. 3, shown is an example of a sequence 303 of c-tokens 112 with the position of the c-token 112 indicating the corresponding egress port 109 (e.g., egress port 0 to egress port N). The number of c-tokens 112 in the sequence 303 corresponds to the number of egress ports 109 in the distributed system 100. Each node 103 of the distributed system 100 begins by transmitting a c-token 112 for each egress port 109 that it supports in the order defined by the sequence 303 and then passes the c-tokens 112 that are received from the other nodes 103 over the c-ring 115. Because the nodes 103 are positioned in series around the c-ring 115, each node 103 can track the position of the c-tokens 112 in the sequence 303 and thus identify the corresponding egress port 109 based upon the predefined sequence 303.

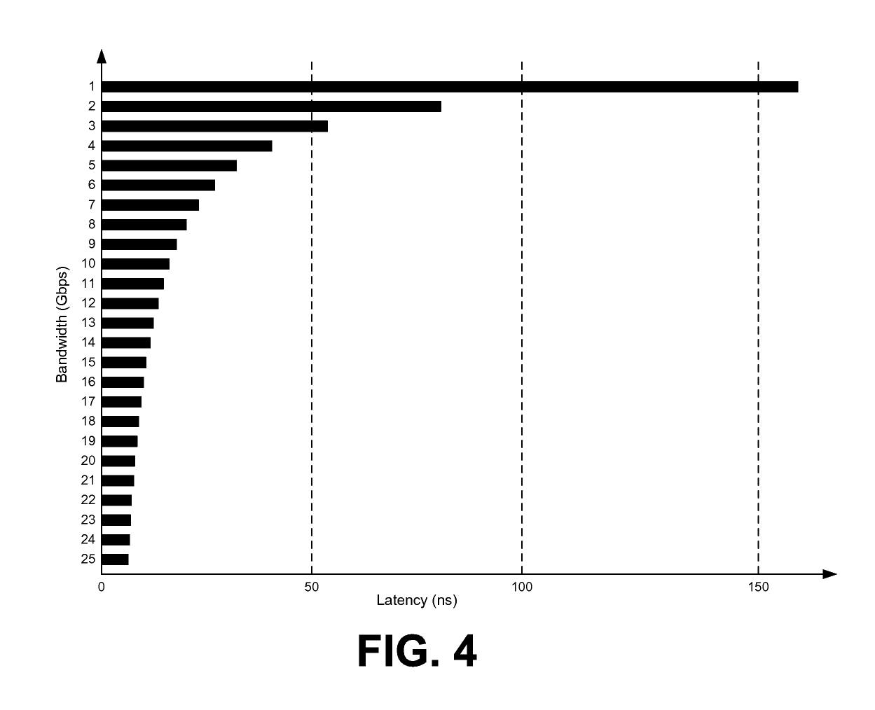

Latency of the c-ring 115 varies based upon the size of the c-tokens 112 and the bandwidth of the c-ring 115. By reducing the size of the c-tokens 112, the latency can be improved. In one embodiment, each c-token 112 in the sequence 303 may comprise a first bit for the eligibility indication 203 and a second bit for the claim indication 206 of FIG. 2A. Assuming two-bits per c-token 112 in a distributed system 100 supporting eighty egress ports 109, then 160 bits would circulate the c-ring 115. The addition of other information in the c-tokens 112 such as, e.g., error correction information 212 would result in additional bits. Referring to FIG. 4, shown in the effect on latency in nanoseconds (ns) for 80 two-bit c-tokens 112 when the bandwidth is varied from 1 gigabit per second (Gbps) to 25 Gbps. At 1 Gbps, it would take about 168 ns to convey the information in all 80 c-tokens 112 to all of the nodes 103 along the c-ring 115. By increasing the bandwidth of the c-ring 115, the latency quickly drops off as illustrated in FIG. 4. At 20 Gbps, the information is conveyed to all nodes 103 with a latency of about 4 ns. The size of the c-tokens 112 and the bandwidth of the c-ring 115 may be adjusted to obtain the desired latency.

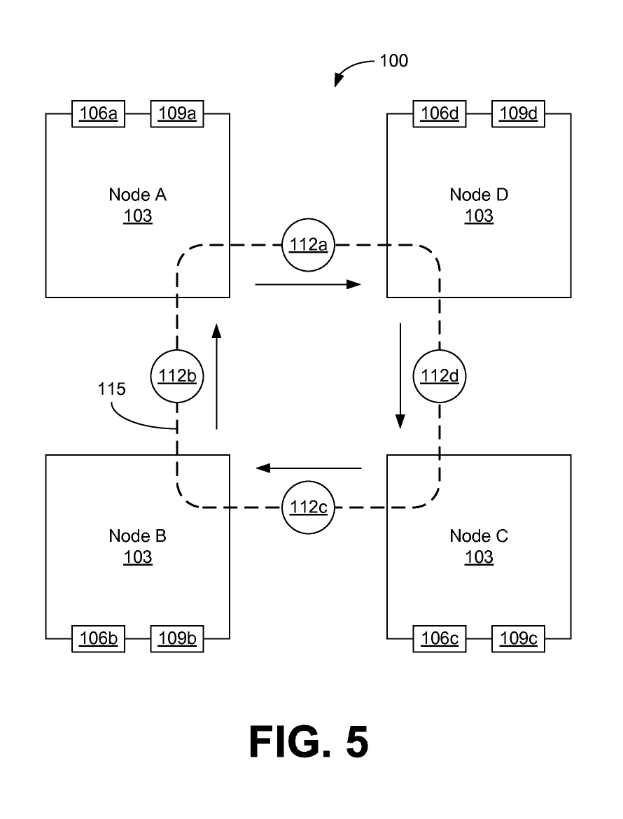

Referring next to FIG. 5, various aspects of the operation of a distributed system 100 will discussed. In the example of FIG. 5, each node A-D 103 supports an ingress port 106a-106d and an egress port 109a-109d. Other combinations of ingress and/or egress port 106/109 may also be supported by the nodes 103 as can be understood. A c-token 112a-112d corresponding to each of the egress ports 109a-109d is passed along the c-ring 115 in a predefined order. Each c-token 112 includes an eligibility indication 203 and a claim indication 206 as illustrated in FIGS. 2A and 2B. When operation of the distributed system 100 begins, the eligibility indication 203 of each c-token 112 may be set to indicate that the corresponding egress port 109 is not available to handle cut-through traffic and the claim indication 206 may be set to indicate that no claim has been made. For example, a two-bit c-token 112 may be initially set to “00” before being passed to then next node 103 on the c-ring 115. As the c-tokens 112 are passed along the c-ring 115, each node 103 examines the c-tokens 112 as they are received to determine whether the corresponding egress port 109 is available to receive cut-through traffic from that node 103. Each node 103 supporting an ingress port 106 is responsible for determining whether to send cut-through traffic to an egress port 109 based at least in part upon the indications of the corresponding c-token 112.

As discussed above, a node 103 supporting an egress port 109 updates the eligibility indication 203 of the corresponding c-token 112 to indicate whether the egress port 109 is available to handle cut-through traffic from another node 103. For example, c-token 112a corresponds to egress port 109a, which is supported by node A 103. When node A 103 receives c-token 112a, it confirms the status of egress port 109a. If egress port 109a is being used for transmission of scheduled traffic and/or will be used to transmit traffic before the c-token 112 returns to node A 103, then the egress port 109a is not available to handle cut-through traffic for this interval or cycle. If the egress port 109a is idle, then the egress port 109a is available to handle cut-through traffic. Node A may then modify the eligibility indication 203 of the corresponding c-token 112 as appropriate. For example, if the eligibility indication 203 of c-token 112a was set to “0” to indicate that egress port 109a was not eligible, then node A 103 can modify the eligibility indication 203 to “1” to indicate that egress port 109a is now eligible or can maintain the eligibility indication 203 as “0” to indicate that egress port 109a is not eligible. Assuming that egress port 109a is eligible to handle cut-through traffic, then two-bit c-token 112a may be modified to “10” before being passed along c-ring 115 to node D 103.

When node D 103 receives c-token 112a, it may determine whether egress port 109a is available to handle cut-through traffic based at least in part upon the eligibility indication 203 of c-token 112a. If egress port 109a is eligible, then node D 103 determines whether another node 103 has claimed the egress port 109a based upon the claim indication 206 of c-token 112a. If egress port 109a has not been claimed, then node D 103 can route at least a portion of a packet and/or frame to egress port 109a for transmission. The traffic can be immediately transmitted via egress port 109a without buffering or storage in node A 103. In some cases, node D 103 will check for error correction before sending the portion of the packet and/or frame to the egress port 109a for transmission. Other conditions may also be considered by node D 103 before the portion of the packet and/or frame is sent to the egress port 109a. Node D 103 also modifies the claim indication 206 of c-token 112a to notify the other nodes 103 that egress port 109a has been claimed before passing the c-token 112a to the next nodes 103. For example, two-bit c-token 112a may be modified to “11” before being passed to then next node 103. In some cases, node D 103 may also update an identifier 209 to show that egress port 109a was claimed by node D 103.

When node C receives the c-token 112a, it may also determine whether egress port 109a is available to handle cut-through traffic. While the eligibility indication 203 of c-token 112a indicates that egress port 109a is eligible, the claim indication 206 of c-token 112a indicates that a previous node 103 has claimed egress port 109a for use. Since egress port 109a is not available to handle cut-through traffic, node C 103 routes incoming packet(s) for egress port 109a to a buffer or other storage for subsequent transmission. When egress port 109a becomes available to handle cut-through traffic, node C 103 may claim the egress port 109a and route at least a portion of the incoming packet(s) from the buffer or other storage to egress port 109a for transmission. C-token 112a is passed from node C 103 to node B 103 without modification, which may also determine whether egress port 109a is available to handle cut-through traffic. Because egress port 109a is not available, node B 103 passes c-token 112a back to node A 103 without modification to complete a cycle or interval.

When c-token 112a returns to node A 103, node A 103 again confirms the status of egress port 109a. If node A 103 has received scheduled traffic for transmission via egress port 109a, then the eligibility indication 203 of c-token 112a is modified to indicate the change in the status of egress port 109a. For example, two-bit c-token 112a may be modified to “01” before being passed to then next node 103. If the traffic from node D 103 is still being transmitted via egress port 109a, then the scheduled traffic is buffered or stored until the transmission has been completed. If the claim is valid for a predefined claim limit such as, e.g., a time period or a defined amount of data, then node A 103 may also delay the scheduled traffic until the claim limit expires. If egress port 109a is still eligible to handle cut-through traffic, then node A 103 does not change the eligibility indication 203 of c-token 112a before passing the c-token 112a to the next node 103.

If node D 103 has not completed routing traffic from ingress port 106d to egress port 109a, then node D 103 may maintain the claim indication 206 when it receives c-token 112a from node A 103. In this way, node D 103 can continue to route traffic for immediate transmission via egress port 109a. If the claim is valid for a predefined claim limit, then node D 103 modifies the claim indication 206 if the claim limit has expired. In some embodiments, the node 103 that supports the ingress port 106 may prematurely release its claim on the corresponding egress port 109 if the eligibility indication 203 indicates that the corresponding egress port 109 is no longer eligible to receive cut-through traffic. For example, if c-token 112a indicates “01” when it is received by node D 103, then node D 103 may prematurely terminate its claim on the egress port 109a and modify the claim indication 206. In that case, when the two-bit c-token 112a returns to node A with an indication of “00” node A can immediately begin handling the scheduled traffic without further delay.

If node D 103 has completed routing traffic to egress port 109a when it receives c-token 112a, then node D 103 may release its claim and modify the claim indication 206. If egress port 109a is still eligible, then the two-bit c-token 112a may be modified to “10” before being passed to then next node 103. Node C 103 or node B 103 may then claim egress port 109a for transmission as described above for node D 103. Each of the other c-tokens 112b, 112c, and 112d of the ordered sequence may be handled in a similar fashion with the node (B, C, and D) 103 supporting the corresponding egress port 109b, 109c, and 109d modifying the eligibility indication 203 of the corresponding c-tokens 112b, 112c, and 112d and the nodes 103 supporting an ingress port 106 modifying the claim indication 206 to claim use of the corresponding egress port 109 109b, 109c, and/or 109d.

Multicasting of traffic may also be supported using the c-tokens 112. For example, if a packet and/or frame is received through ingress port 106c for transmission through egress ports 109b and 109d, then supporting node C 103 can claim both egress ports 109b and 109d when the corresponding c-tokens 112b and 112d indicate that the egress ports 109b and 109d are available to handle cut-through traffic. When node C 103 receives c-token 112b, node C 103 may determine whether egress port 109b is available to handle cut-through traffic based at least in part upon the eligibility indication 203 of c-token 112b. If egress port 109b has not been claimed by another node 103, then node C 103 can begin routing the packet and/or frame to egress port 109b and can modify the claim indication 206 of c-token 112b to notify the other nodes 103. In the same way, when node C 103 receives c-token 112d, node C 103 may determine whether egress port 109d is available to handle cut-through traffic based at least in part upon the eligibility indication 203 of c-token 112d. If egress port 109d has not been claimed by another node 103, then node C 103 can begin routing the packet and/or frame to egress port 109d and can modify the claim indication 206 of c-token 112d to notify the other nodes 103. Additional egress ports 109 may be claimed in the same fashion. The packet and/or frame received through ingress port 106c may be buffered or stored to accommodate the staggered routing of the packet and/or frame to the different egress ports 109.

While the example of FIG. 5 illustrates the nodes 103 supporting a single egress port 109, in other embodiments multiple egress ports 109 may be supported by each node 103. In that case, a plurality of c-tokens 112, each corresponding to one of the plurality of egress ports 109, are sequentially passed between each of the nodes 103 along the c-ring 115. Each node 103 may include a buffer to allow the c-tokens 112 to be passed in order. For example, if a node 103 supports a number of egress ports 109, then the buffer may be configured to buffer at least the same number of c-tokens 112. In this way, the order of the sequence of c-tokens 112 can be maintained as they circulate around the c-ring 115.

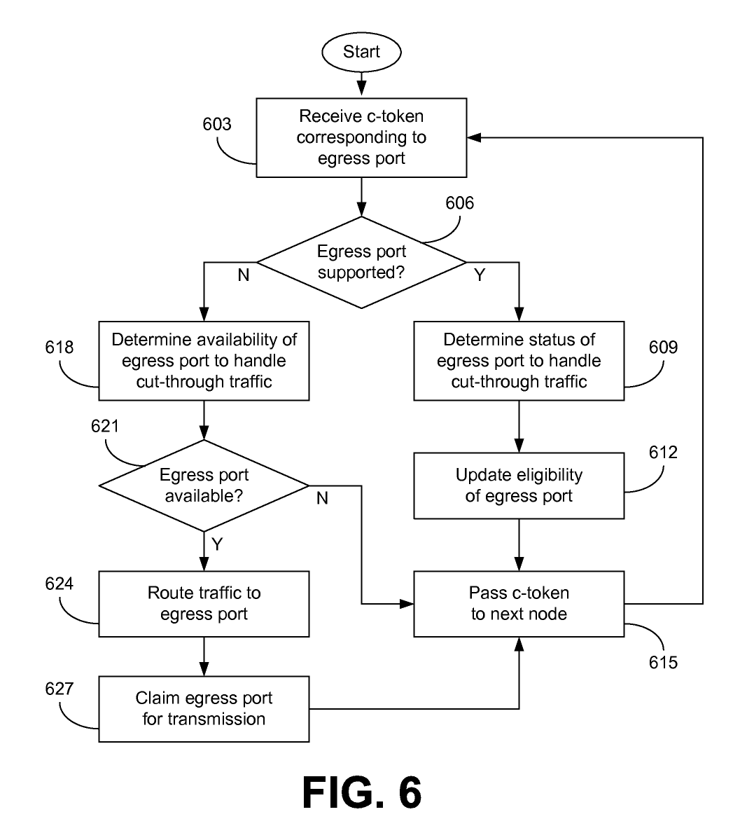

Referring now to FIG. 6, shown is a flow chart illustrating an example of traffic flow management within a distributed system 100 using c-tokens 112. Beginning with 603, a node 103 of a distributed system 100 receives a c-token 112 corresponding to an egress port 109 of the distributed system 100 of FIGS. 1 and 5. In 606, the node 103 determines if it supports the corresponding egress port 109. For example, the node 103 may determine the identity of the corresponding egress port 109 based upon the position of the c-token 112 within the ordered sequence of c-tokens 112 passed between nodes 103 of the distributed system 100. If the corresponding egress port 109 is supported by the node 103, then the eligibility of the corresponding egress port 109 to handle cut-through traffic is determined at 609. If the corresponding egress port 109 is idle, than the corresponding egress port 109 can be considered eligible to transmit cut-through traffic without delay. For example, if node A 103 of FIG. 5 receives an incoming packet and/or frame through ingress port 106a that is to be routed through egress port 109a (or one of the other egress ports 109b-109d), then the incoming packet and/or frame is handled based upon the eligibility of egress port 109a (or 109b-109d) to handle cut-through traffic. Some or all of the incoming packet and/or frame may be stored or buffered before the corresponding c-token 112a (or 112b-112d) is received. If the egress port 109a (or 109b-109d) is not eligible, then the incoming packet and/or frame can be stored until the egress port 109a (or 109b-109d) becomes eligible. If the egress port 109a (or 109b-109d) is eligible, then the incoming packet and/or frame may be routed directly to egress port 109a (or 109b-109d). The eligibility of the corresponding egress port 109 may be updated in 612. If the status has changed, then the eligibility indication 203 (FIGS. 2A and 2B) of the c-token 112 is modified to notify the other nodes 103 of the distributed system 100. In 615, the c-token 112 is then passed to the next node 103 along the c-ring 115 of the distributed system 100 (FIGS. 1 and 5). The flow then returns to 603 to receive another c-token 112 corresponding to another egress port 109 of the distributed system 100.

If the corresponding egress port 109 is not supported by the node 103 in 606, then the availability of the corresponding egress port 109 to handle cut-through traffic is determined at 618. The node 103 may determine whether the corresponding egress port 109 is available to handle cut-through traffic based at least in part upon the eligibility indication 203 of the c-token 112. If the corresponding egress port 109 is eligible to handle cut-through traffic, then the node 103 may determine whether the corresponding egress port 109 has been claimed by another node based upon the claim indication 206 of the c-token 112. If the corresponding egress port 109 is not eligible or has been claimed by another node 103, then the corresponding egress port 109 is not available at 621 and the c-token 112 is then passed to the next node 103 along the c-ring 115 of the distributed system 100 in 615. The flow then returns to 603 to receive another c-token 112 corresponding to another egress port 109 of the distributed system 100.

If the corresponding egress port 109 is eligible to handle cut-through traffic and the corresponding egress port 109 has not been claimed by another node 103 in 621, then in 624 the node 103 may route traffic received through a supported ingress node 106 to the corresponding egress port 109 for immediate transmission. The node 103 also claims the corresponding egress port 109 for transmission in 627 by modifying the claim indication 206 of the c-token 112. In 615, the c-token 112 is then passed to the next node 103 of the distributed system 100. The flow then returns to 603 to receive another c-token 112 corresponding to another egress port 109 of the distributed system 100.

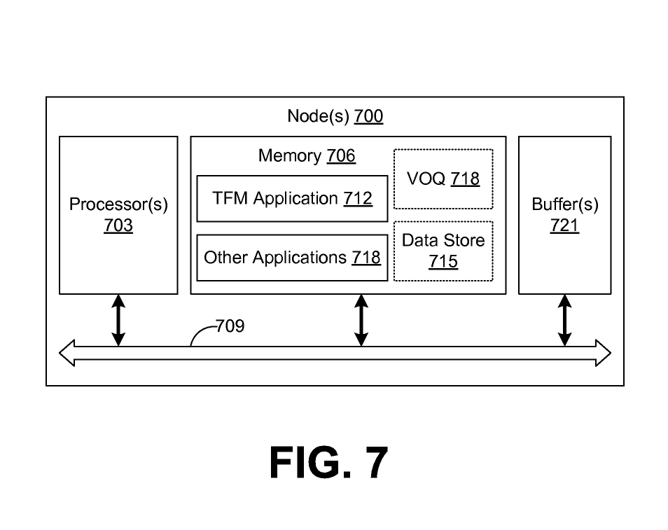

With reference to FIG. 7, shown is a schematic block diagram of a node 700 according to various embodiments of the present disclosure. The node 700 may include a processor circuit, for example, having a processor 703 and a memory 706, both of which are coupled to a local interface 709. To this end, the node 700 may comprise, for example, a single die in a chip, one or more chips in a device, and/or one or more devices in a system. The local interface 709 may comprise, for example, a data bus with an accompanying address/control bus or other bus structure as can be appreciated. The node may also include one or more buffers 721 for handling the flow of packets, frames, and/or cut-through tokens. In some implementations, the node 700 may store scheduled traffic (or even a portion of unscheduled traffic) in a buffer 721 and/or memory 706 for subsequent transmission through an egress port of the distributed system.

Stored in the memory 706 may be both data and several components that are executable by the processor 703. In particular, stored in the memory 706 and executable by the processor 703 may be a traffic flow management (TFM) application 712 and potentially other applications 718. Also stored in the memory 706 may be a data store 715 and other data. One or more virtual output queues 718 may also be stored in memory 706. In addition, an operating system 721 may be stored in the memory 706 and executable by the processor 703.

It is understood that there may be other applications that are stored in the memory 706 and are executable by the processors 703 as can be appreciated. Where any component discussed herein is implemented in the form of software, any one of a number of programming languages may be employed such as, for example, C, C++, C#, Objective C, Java, Java Script, Perl, PHP, Visual Basic, Python, Ruby, Delphi, Flash, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and the memory 706 may represent multiple memories 706 that operate in parallel processing circuits, respectively. In such a case, the local interface 709 may be an appropriate network that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the TFM application 712, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flow chart of FIG. 6 shows functionality and operation of an implementation of portions of a TFM application 712. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flow chart of FIG. 6 shows a specific order of execution, it is understood that the order of execution may differ from that which is depicted. For example, the order of execution of two or more blocks may be scrambled relative to the order shown. Also, two or more blocks shown in succession in FIG. 6 may be executed concurrently or with partial concurrence. Further, in some embodiments, one or more of the blocks shown in FIG. 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the TFM application 712 that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A distributed system, comprising:
a plurality of egress ports, each egress port supported by one of a plurality of nodes included in the distributed system;
a plurality of cut-through tokens (c-tokens), each c-token corresponding to one of the plurality of egress ports, each c-token including an indication of eligibility of the corresponding egress port to handle cut-through traffic; and
a cut-through control ring (c-ring) configured to pass the plurality of c-tokens between each of the plurality of nodes.

2. The distributed system of claim 1, wherein the eligibility indication is a bit of the c-token.

3. The distributed system of claim 1, wherein each c-token includes a claim indication that indicates whether the corresponding egress port has been claimed to handle traffic from an ingress port supported by one of the plurality of nodes.

4. The distributed system of claim 3, wherein the eligibility indication is a first bit of the c-token and the claim indication is a second bit of the c-token.

5. The distributed system of claim 3, wherein each c-token includes an ingress port identifier indicating the source of the traffic handled by the egress port.

6. The distributed system of claim 1, wherein the plurality of c-tokens are passed to each of the plurality of nodes in an ordered sequence, where the position of each c-token within the ordered sequence identifies the corresponding egress port.

7. The distributed system of claim 1, wherein a node of the plurality of nodes is configured to:
determine whether an egress port supported by the node is available to handle cut-through traffic; and
modify the eligibility indication of the c-token corresponding to the egress port supported by the node to indicate the determined availability.

8. The distributed system of claim 1, wherein a node of the plurality of nodes is configured to:
determine whether one of the plurality of egress ports is available to handle cut-through traffic based at least in part upon the eligibility indication of the corresponding c-token; and
route at least a portion of a packet to the one egress port for transmission in response to the determined availability of the one egress port.

9. A method, comprising:
determining whether an egress port of a distributed system is available to handle cut-through traffic based upon a cut-through token (c-token) corresponding to the egress port;
in response to the availability of the egress port, claiming the egress port for transmission of at least a portion of a packet received through an ingress port of the distributed system; and
routing the at least a portion of the packet to the claimed egress port for transmission.

10. The method of claim 9, wherein the c-token includes an eligibility indication that indicates whether the corresponding egress port is eligible to handle cut-through traffic.

11. The method of claim 10, wherein the availability of the egress port is based at least in part upon the eligibility indication of the corresponding c-token.

12. The method of claim 10, wherein the c-token includes a claim indication that indicates whether the corresponding egress port has been claimed to handle traffic from another ingress port.

13. The method of claim 12, wherein the availability of the egress port is based at least in part upon the eligibility indication and the claim indication of the corresponding c-token.

14. The method of claim 9, wherein claiming the egress port for transmission comprises configuring a claim indication of the c-token to indicate that the corresponding egress port has been claimed to handle traffic from the ingress port.

15. The method of claim 9, wherein the at least a portion of the packet is routed from the ingress port to the claimed egress port without storing the at least a portion of the packet during routing.

16. The method of claim 9, comprising:
claiming a plurality of egress ports available to handle cut-through traffic for transmission of the at least a portion of the packet; and
routing the at least a portion of the packet to each of the claimed egress ports for multicast transmission.

17. A distributed system, comprising:
a first node configured to modify an eligibility indication of a cut-through token (c-token) corresponding to an egress port supported by the first node before transmission of the c-token to a second node of the distributed system, the eligibility indication indicating the availability of the corresponding egress port to handle cut-through traffic of the distributed system; and
the second node configured to route at least a portion of a packet received through an ingress port supported by the second node based at least in part upon the eligibility indication of the c-token.

18. The distributed system of claim 17, wherein the at least a portion of the packet is routed from the ingress port supported by the second node to the egress port supported by the first node for transmission without buffering the at least a portion of the packet.

19. The distributed system of claim 17, wherein the at least a portion of the packet is routed from the ingress port supported by the second node to a buffer for subsequent transmission.

20. The distributed system of claim 17, wherein the c-token is transmitted to the second node via a third node of the distributed system.
